(19) United States
(12) Patent Application Publication
(10) Pub. No.: US 2012/0055375 A1
(43) Pub. Date: Mar. 8, 2012

(54) GEOTHERMAL GROUT, AND METHODS OF PREPARING AND UTILIZING SAME

(76) Inventor: JEFFREY J. KONCZAK, Alpena, MI (US)

(21) Appl. No.: 13/296,093

(22) Filed: Nov. 14, 2011

Related U.S. Application Data
(62) Division of application No. 12/235,599, filed on Sep. 22, 2008, now abandoned.

(51) Int. Cl. C04B 18/06

(52) U.S. Cl. 106/707

(57) ABSTRACT

A thermally enhanced, single component, geothermal grout from recycled materials, such as class F fly ash and cement kiln dust. Additional components can include a mid-range water reducer and a dry caustic.

### CROSS-REFERENCE TO RELATED APPLICATIONS

Not Applicable.

### STATEMENT REGARDING FEDERALLY SPONSORED RESEARCH OR DEVELOPMENT Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates to a novel and unique thermally enhanced geothermal grout, and methods of preparing and utilizing same.

More particularly, the present invention relates to a novel and unique thermally enhanced geothermal single component grout from recycled materials, and methods of preparing and utilizing same.

A “single component grout” is intended to mean single bag plus water to make finished grout, incontrast to the typical 4 bags of silica sand +1 bag of Bentonite +Water Reducing Admixture +1 bag of Portland cement for certain mixtures.

The term “Geo SuperGrout™” as used herein means grout prepared in accordance with the present invention.

Geo SuperGrout™ was developed to fill a market need for a superior functioning bore-hole grout that would have a high degree of thermal conductivity, but would resist shrinkage and cracking that is prevalent in nearly all currently available grout products. Additionally, these products typically require multiple components making it further complicated for installers to inventory, haul and deliver such material to the bore-hole.

In geothermal direct exchange (DX) or water loop in ground heat pump systems, bore-holes range from 100-300 feet in depth, are generally 4-6 inches in diameter, and include a “loop” which can be made of copper or PVC. Generally, one loop is installed for each “ton” of heating and cooling capacity for the building. A typical installation is between 4-6 loops for the average sized household. Once the loop is installed, the bore-hole is closed with a thermally enhanced grout. Approximately 95% of these holes world-wide utilize a Bentonite mixture with silica sand. The mixtures are difficult to maintain flowability while placing, and nearly impossible to pump through drilling contractors on-board mud pumps. This requires additional pump equipment for placement of the mixed grout. Many bore-holes are subject to bridging, so laborers are accustomed to adding too much water in an effort to make the mixture more flowable, but few laborers understand the damage that they are creating to the performance of the installed system with every ounce of water added.

Through the development of Geo SuperGrout™, applicant has performed side-by-side testing of nearly all available Bentonite grout mixtures, as well as several other available products, and have witnessed many performance flaws to the other systems. The most significant flaw to all bentonite/silica materials is that they all shrink, crack and separate from the loops. They particularly perform poorly in the Vadose Zone which are typically dryer elevations in the ground above the water tables. Because Bentonite does not set, the excess moisture added is absorbed into the surrounding soils and shrinks dramatically.

The higher the water addition for flowability, the higher level of shrinkage and cracking that occurs. These cracks and fissures create air gaps along surfaces of the loop, which effects heat transfer and temperature re-generation which is the main performance criteria to these in-ground heat pump systems. Additionally, ground water can also fill these voids and degrade the performance of the heat transfer.

Geo SuperGrout™ was conceived to fill the void in the marketplace for a high performing product that would eliminate most of the problems associated with currently available grout products.

It is a desideratum of the present invention to avoid the animadversions of conventional grout, and provide a superior grout.

### SUMMARY OF THE INVENTION

The present invention provides a thermally enhanced grout from recycled materials.

The present invention provides a thermally enhanced geothermal grout, comprising: class F fly ash in a range of approximately 50 to 80% by weight of said grout; and cement kiln dust in a range of approximately 20 to 50% by weight of said grout.

The present invention also provides a method of preparing a thermally enhanced geothermal grout from recycled materials, comprising the steps of: preparing a single component dry grout mixture comprising approximately 50-80% class F fly ash and approximately 20-50% cement kiln dust; adding approximately five gallons of water to approximately 70 pounds of said dry grout mixture; adding a mid-range water reducer at an addition rate of approximately 0-8 fluid ounce equivalent per hundred-weight of said dry grout mixture; and adding dry sodium hydroxide at an addition rate of between approximately 0-12 dry ounces per hundred weight of said dry grout mixture.

It is a primary object of the present invention to provide a thermally enhanced geothermal grout from recycled materials.

Another object of the present invention to provide a a thermally enhanced geothermal grout from recycled materials which is a single component grout.

Other objects, advantages, and features of the present invention will become apparent to those persons skilled in this particular area of technology and to other persons after having been exposed to the present patent application when read in conjunction with the accompanying patent drawings.

### BRIEF DESCRIPTION OF THE DRAWINGS

FIG. 1 is a microscopic photograph of the prior art.

FIG. 2 is a microscopic photograph of Geo SuperGrout™.

### DETAILED DESCRIPTION OF THE INVENTION

Geo SuperGrout™ is a single component grout consisting of 50-80% by weight of class “F” fly ash and 20-50% by weight of Cement Kiln Dust (CKD). These raw materials are pre-blended into one bag. Bags are clearly marked to add “5” gallons of water per bag. When five gallons of water is added to each 70 pound bag, the yield of finished grout is then seven gallons.

Additionally, there are two other dry chemical components to aid in the performance of Geo SuperGrout.

The first, dramatically enhances flowability of the mixed grout, and is commonly known as a mid-range water reducer. The preferred materials are either a naphthalene or lignosulphonate, commonly known as a “lignin”. The addition rate depends on the physical characteristics of the fly ash component, as the particles of fly ash are typically round, hollow spheres. The addition rate of the mid-range water reducer is 0-8 fluid ounce equivalent per CWT (hundred-weight) of dry grout mixture.

The second dry chemical addition to the blended bagged product is used to help artificially “hydrate” the fly ash particles. It is in the form of a caustic known as sodium hydroxide. Because Class “F” fly ash has calcium oxide (CaO) under the hard, non-reactive layer of silica (SiO₂), the sodium hydroxide is used to perforate the shell of the fly ash particle, which opens up the calcium oxide (CaO) hydration, thus hardening the grout when in place. The addition rate of the dry “caustic” is between 0-12 dry ounces per CWT (hundred-weight).

Geo SuperGrout™ involves a balance of component chemistries. In particular, depending on the fly ash and the cement kiln dust (CKD) location of manufacture, the available chemistries of those raw materials sometimes require very little sodium hydroxide, and based on the finesse and particle shape of the fly ash, it may require very little lignin (water reducer). The present invention includes the flexibility to determine what is needed based on the manufacturing location, so when blended the performance is consistent. It is extremely rare that the first and second chemical additions will ever be at zero on these components, but it is statistically possible.

Unlike other grouting materials in the market, Geo SuperGrout™ hydrates and hardens within 24-48 hours. This is critical to counteract the shrinkage due to the Vadose Zone, or internal shrinkage, as the stiffening helps secure the particles in place. Calcium silicate hydrate (CSH) is microscopic siliceous glass crystals that grow and surround all particles in the paste matrix. These crystals act as both strength and stiffness against shrinkage pressures. As long as there is moisture available, hydration continues in perpetuity and continually reduces permeability, as well as increases thermal conductivity. Because fly ash particles are silica, the hydration product is silica, the cement kiln dust (CKD) is silica, and that the particle sizes are so small and numerous, thermal conductivity is enhanced because all surfaces of non-similar shapes are touching.

Typical grouts made from Bentonite/Silica Sand mixtures are flooded with water to make the jagged rough particles flow around each other; however, the more water the more shrinkage since these products typically dehydrate, rather than hydrate like Geo SuperGrout™. The water in such mixtures is absorbed into the surrounding soil, and is most damaging in the Vadose Zone. This zone is typically dryer that most ground soils and absorbs water quickly. The result is severe shrinkage and voids around the loops and the annular space in the borehole. A typical Bentonite/Silica Sand mixture is 1:4 Bentonite to sand ratio. The performance of any system is the transfer of heat from the loop to the surrounding soils and the regeneration of needed loop temperatures as the coolant or water is returned to the pump system for compressing further. When these mixtures stop being agitated by a mixer or pump, they quickly settle and separate. The water rises to the top of the bore hole and the heavier bentonite and silica sand settle at varying levels in the loop. Shrinkage takes place, and in 24 hours, one can see evidence of significant shrinkage at the top of the hole, sometimes as much as 20-25% of the depth is now void. Additionally, annular shrinkage and cracking near loops creates problems of performance. If the mixture of bentonite and sand would reach marketed thermal conductivity of 1.0 btu/hr-ft-F using ASTM D1554, air voids only measure 0.02 btu/hr-ft-F. Air voids essentially eliminates the ability to transfer the heat from the loops to the surrounding soils.

In contrast, Geo SuperGrout™ performs very well with very little shrinkage, no cracking and tight bond around the copper loops.

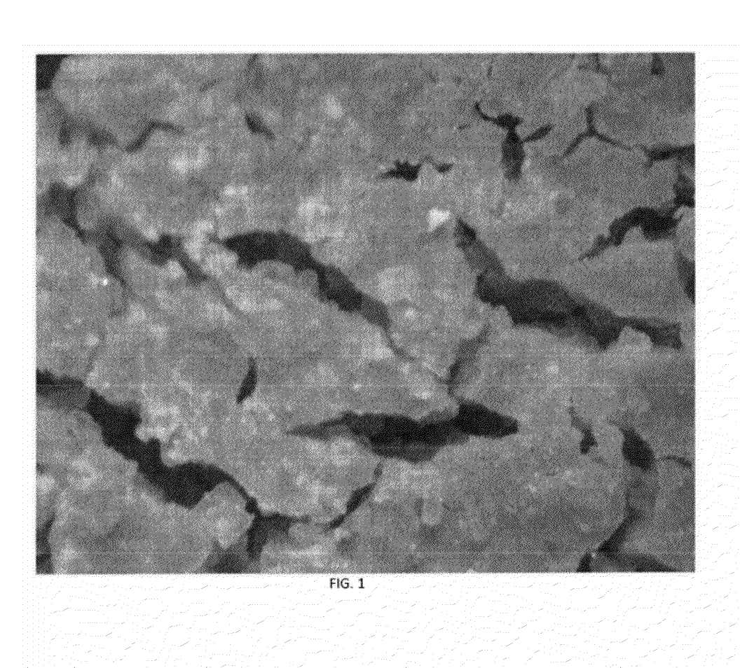

FIG. 1 is a microscopic photograph of bentonite/silica sand 1:4 ratio (40×).

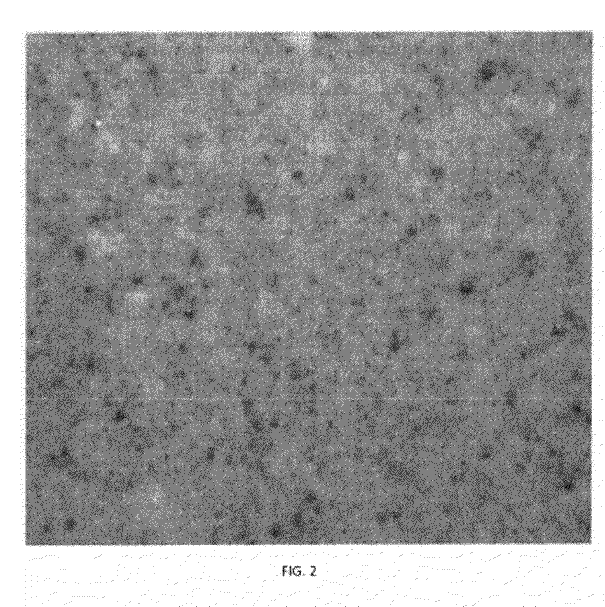

FIG. 2 is a microscopic photograph of Geo SuperGrout™ (40×). Notice the marble like surface with no pronounced void spacing. The black specks are carbon in the fly ash. The particles are extremely small and close in around each other giving a dense impervious structure. This density and non-porosity increases over time as a result of hydration.

Furthermore, the following thermal conductivity results were values generated by performing ASTM D1554, which is a standard used by all grout manufacturers. The results are taken at the same age in a plastic state at 48 hours. Values will rise at older ages; however, Geo SuperGrout™ is the only material stiff enough at 7 days to compare. All Bentonite mixes are still very fluid resulting in lower than promoted values.

| Material | Result 48 hrs |
|---|---|
| Geo Pro Blackhills Bentonite .57 | 0.40 Btu/hr-ft-F. |
| Geo Pro Blackhills Bentonite 1.0 | 0.55 Btu/hr-ft-F. |
| Thermex Bentonite 0.93 | 0.65 Btu/hr-ft-F. |
| IDP-357 Graphite/Bentonite | 1.10 Btu/hr-ft-F. |
| Geo SuperGrout ™ | 0.80 Btu/hr-ft-F. |

Although IDP 357 has a very high value, the price of $90.00 per 50# bag makes it unreasonable to use in geothermal applications.

Also, because Geo SuperGrout™ is unlike other geothermal grouting materials and includes cementitious properties, significant amounts of additional calcium silicates are produced upon hydration and hardening which reduces significantly the permeability of hydraulic and non-hydraulic liquids. These silicates are also an effective neutralization of any concerns related to surrounding acidic soil conditions and provides perpetual protection of the system from such soils.

The following describes the grout weight and solids of an example using Geo SuperGrout™.

### Solids of Fresh Grout:

Solids by weight of slurry: 62.7% (5.0 gallons of water per 70# bag, OR 0.595 W/C ratio)

### Weight per Gallon of Finished Grout (US):

Dry Mixture: 70.00 lbs

Water (5 gal): 41.65 lbs

Total: 111.65 lbs

Yield: 7.0 Gallons

Weight Per Gallon: 15.95 lbs/Gallon.

There has been described hereinabove only one possible unique and novel embodiment of the present invention which can be practiced using many different materials and proportions thereof.

It should be understood that many changes, modifications, variations, and other uses and applications will become apparent to those persons skilled in this particular area of technology and to others after having been exposed to the present patent application.

Any and all such changes, modifications, variations and other uses and applications which do not depart from the spirit and scope of the present invention are therefore covered by and embraced within the present invention and the patent claims set forth hereinbelow,

1-19. (canceled)

20. A method of preparing a thermally enhanced geothermal grout from recycled materials, comprising the steps of:
preparing a single component dry grout mixture comprising approximately 50-80% class F fly ash and approximately 20-50% cement kiln dust;
adding approximately five gallons of water to approximately 70 pounds of said dry grout mixture;
adding a mid-range water reducer at an addition rate of approximately 0-8 fluid ounce equivalent per hundred-weight of said dry grout mixture; and
adding dry sodium hydroxide at an addition rate of between approximately 0-12 dry ounces per hundred weight of said dry grout mixture.
